(19) United States
(12) Patent Application Publication
(10) Pub. No.: US 2025/0072461 A1
(43) Pub. Date: Mar. 6, 2025

(54) COCONUT DRILLING, TAPPING, AND FLAVORING DEVICE AND METHOD THEREFOR

(71) Applicant: VINCENT ZALDIVAR, LAS VEGAS, NV (US)

(72) Inventor: VINCENT ZALDIVAR, LAS VEGAS, NV (US)

(73) Assignee: Monarch Media, LLC, Las Vegas, NV (US)

(21) Appl. No.: 18/241,955

(22) Filed: Sep. 4, 2023

(51) Int. Cl. A23N 5/03; A23N 15/06; A47J 31/40

(52) U.S. Cl. CPC A23N 5/03; A23N 15/06; A47J 31/402

(57) ABSTRACT

A coconut processing device has a drill unit forming an opening in a coconut; and a capping unit inserting a spout into the opening sealing the opening.

### RELATED APPLICATIONS

This patent application is related to U.S. Pat. No. 10,609,939, issued on Apr. 7, 2020, and U.S. Pat. No. 11,317,647, issued on May 3, 2022 both assigned to Monarch Media, LLC, Las Vegas, NV, and which are incorporated herein by reference in its entirety.

### TECHNICAL FIELD

The present application in general relates to coconuts, and more specifically, to a system and method to form an opening in a coconut, add a desire flavoring or beverage mixer to the coconut, and seal the opening formed with a drinking spout.

### BACKGROUND

Coconut water is a liquid that forms naturally inside the shell of a coconut. It is a common drink in many tropical countries and is becoming more popular in the United States as many companies are marketing it as a natural sports drink. Coconut water has fewer calories, less sodium, and more potassium than most sports drink. Ounce per ounce, most unflavored coconut water contains 5.45 calories, 1.3 grams sugar, 61 milligrams (mg) of potassium, and 5.45 mg of sodium compared to Gatorade®, which has 6.25 calories, 1.75 grams of sugar, 3.75 mg of potassium, and 13.75 mg of sodium.

Coconut water should not be confused with high-fat coconut milk or oil. Coconut water is a clear liquid in the fruit's center that is tapped from young, green coconuts.

Presently, there is no easy way to remove the coconut water from within the coconut. In general, most people try to find the soft “eye” of the coconut. The soft “eye” is a black spot located at the top of the coconut. Once the soft “eye” of the coconut is located, a person may use a metallic skewer such as a screwdriver to pierce the coconut. Alternatively, a nail and a hammer may be used to create the opening in the soft “eye”.

Once the soft “eye” has been pierced, the skewer may be pushed towards the interior of the coconut. The skewer may then be removed and the coconut water may be drained into a bowl or other container.

Unfortunately, the above method is not easy. Further, it does not allow one to easily drain the coconut water. Many times, after removing the skewer and trying to drain the coconut water, the coconut water tends to hug the side of the coconut and spill never reaching the bowl.

Presently, there is no system/machine that can form openings in a coconut in fast production manner. For example, at a resort, restaurant, amusement park, or other areas hosting large gatherings, there is currently no way to open and serve a drink in the opened coconut to a large customer base in a quick manner. Further, once an opening is made, there is no system/machine that can seal the opening so that the coconut water remains fresh but easily accessible to be drank.

Further, at these establishments, not all customers may want plain coconut water to drink. Some customers may want to mix flavoring and/or other beverages or content with the coconut water. Once an opening is formed in the coconut, it is difficult for a bartender or other person to pour different flavorings and/or beverages or content into the opening formed in the coconut. Thus, the ability to serve different mixed drinks within the open coconut in a fast manner to multiple customers at a large gathering is difficult.

Many resorts, restaurants, amusement parks, or other areas hosting large gatherings may want to customize the coconut before serving the drink to the customer. These establishments may want to add a logo and/or company name for advertisement or other purposes. These establishments may further want to add text such as “Happy Birthday”, “Happy Anniversary”, “Congratulations” or similar text if a customer is celebrating a particular occasion and/or event. Unfortunately, there is no system/machine that can customize the coconut with logos and/or text in a quick and efficient manner for establishments hosting large gatherings.

Therefore, it would be desirable to provide a system and method that overcomes the above. The system and method would be able to drill an opening in a coconut and seal the opening with a drinking spout in a mass production manner. The system and method would be able to add additional flavoring/mixes into the coconut that has been drilled prior to sealing the opening. The system and method would also be able to brand the coconut to be drilled and sealed.

### SUMMARY

In accordance with one embodiment, a coconut processing device is disclosed. The coconut processing device has a drill unit forming an opening in a coconut. A capping unit inserts a spout into the opening sealing the opening.

In accordance with one embodiment, a coconut processing device is disclosed. The coconut processing device has a housing having an opening formed in a bottom area of the housing. A stand is positioned under the housing holding the housing. A retractable drill unit is movable in and out of the housing forming an opening in a coconut positioned below the opening in the housing. A retractable capping unit is movable in and out of the housing inserting a spout into the opening in the coconut sealing the opening in the coconut. A retractable flavoring unit places a flavoring in the coconut. A retractable branding unit is movable in and out of the housing placing a label on the coconut.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a perspective view of an exemplary device for drilling and sealing a coconut in accordance with one aspect of the present application;

FIG. 2 is a block diagram of the exemplary device for drilling and sealing a coconut shown in FIG. 1 according to one aspect of the present application;

FIG. 3 is a perspective view of an exemplary coconut having a hole formed by the device of FIG. 1 in accordance with one aspect of the present application; and

FIG. 4 is a perspective view of an exemplary coconut having a spout inserted into the hole formed by the device of FIG. 1 in accordance with one aspect of the present application.

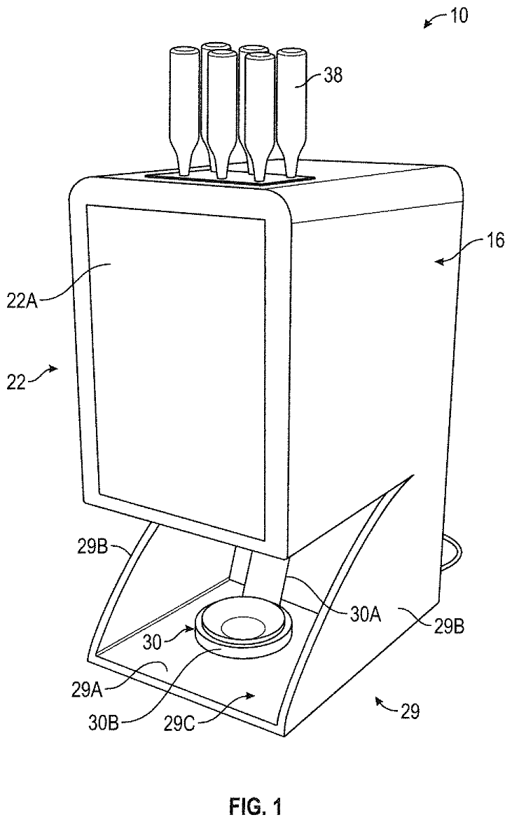

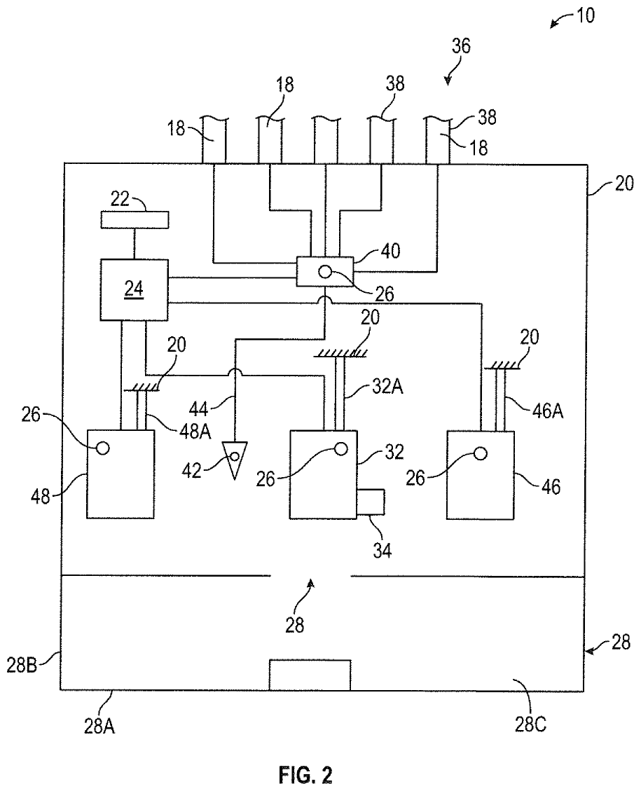

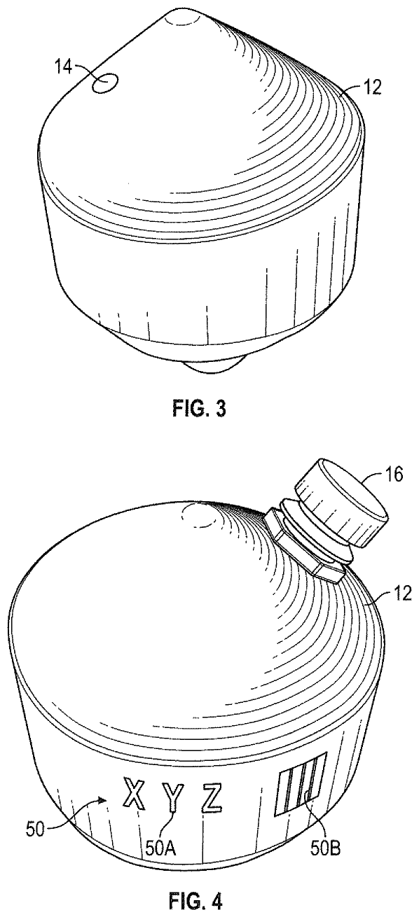

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method relate to a device and method for the production of drilled and sealed coconuts for mass productions and/or establishments hosting large gathers. The device and method would be able to drill an opening into a coconut and seal the opening with a resealable drinking spout. The device and method would be able to mix flavoring or other mixtures into the drilled coconut prior to the opening being sealed with the resealable drinking spout. The device and method may further be able to customize the exterior of the coconut being drilled.

Referring now to the FIGs., a device 10 for drilling and sealing a coconut 12 may be shown. The device 10 may be able to form an opening 14 within the coconut 12 while preventing any debris from the coconut 12 from entering an interior of the coconut 12. Once the opening 14 may be formed, the device 10 may insert a resealable drinking spout 16 into the opening 14 formed to allow a user to drink the coconut water within the interior of the coconut 12 and to seal the coconut 12 to keep the coconut water fresh. The device 10 may be able to mix flavoring 18 or other mixtures/beverages (hereinafter flavoring 18) into the drilled coconut 12 prior to the opening 14 being sealed with the resealable drinking spout 16. The device 10 may further be able to customize the exterior of the coconut 12 being drilled as may be disclosed below.

The device 10 may be formed of a housing 20. The housing 20 may be used to enclose the components forming the device 10. The housing 20 may have a screen 22 located on a front section of the housing 20. The screen 22 may be used to control operations of the device 10. The screen 22 may be an Input/Output (I/O) device allowing a user to enter commands and receive operating conditions of the device 10. In accordance with one embodiment, the screen 22 may be a touch screen 22A. The touch screen 22A may be used to enter commands into the device 10 to control operations of the device 10 as well as see operating conditions of the device 10.

The screen 22 may be coupled to a control unit 24. The control unit 24 may be used to send commands entered into the screen 22 to the different components of the device 10. The control unit 24 may further monitor one or more sensors 26 coupled to the components of the device 10. The control unit 24 may monitor the sensors 26 to control operation of the different components. The control unit 24 may monitor the sensors 26 to relay the information recorded by the sensors 26 to the screen 22 so that a user may see the operating conditions of the device 10.

An opening 28 may be formed in a bottom surface of the housing 20. The opening 28 may be used to allow one or more of the components of the device 10 to extend out of the housing 20 to perform a function on the coconut 12 as may be described below.

A stand 29 may be positioned below the housing 20 and secures the housing 20 in an upright position. In accordance with one embodiment, the stand 29 may have a bottom plate 29A. Side walls 29B may extend up from the bottom plate 29A. The side walls 29B may be attached to the housing 20 securing the housing 20 to the stand 29. The stand 29 may have an open front area 29C. The open front area 29C may allow the user of the device 10 to insert the coconut 12 within the stand 29 so that the device 10 may perform a desired function on the coconut 12. In accordance with one embodiment, the coconut 12 may be positioned through the open front area 29C, on the bottom plate 29A and under the opening 28 of the housing 20 so that the device 10 may perform a desired function on the coconut 12.

A securing mechanism 30 may be positioned below the opening 28. In accordance with one embodiment, the securing mechanism 30 may extend down from the housing 20 and extend below the opening 28. The securing mechanism 30 may be used to hold the coconut 12 in position below the opening 28 while the device 10 performs different functions on the coconut 12 as may be described below. In accordance with one embodiment, the securing mechanism 30 may be formed of an arm 30A which extends down from the housing 20. A cradle 30B may extend from the arm 30A. The cradle 30B may secure the coconut 12 in place and positioned the coconut 12 below the opening 28 so that the different components of the device 10 may perform one or more functions on the coconut 12.

The device 10 may be able to form an opening 14 within the coconut 12. In accordance with one embodiment, the device 10 may be able to form the opening 14 within the coconut 12 while preventing any debris from the coconut 12 from entering an interior of the coconut 12. In accordance with one embodiment, the device 10 may have a drill unit 32. The drill unit 32 may be positioned within the housing 20. The drill unit 32 may be movable such that the drill unit 32 may move downward through the opening 28 of the housing 20 to reach the coconut 12 to be drilled. In accordance with one embodiment, the drill unit 32 may be coupled to an extendable arm 32A. The extendable arm 32A may have one end coupled to the housing 20 and a second end coupled to the drill unit 32. The extendable arm 32A may extend downward so that the drill unit 32 extends through the opening 28 of the housing 20 to reach the coconut 12 to be drilled. Once the opening 14 is formed in the coconut 12, the extendable arm 32A may be retracted so that the drill unit 32 is positioned back within the housing 20.

As stated above, the drill unit 32 may be configured to prevent any debris from the coconut 12 from entering the interior of the coconut 12. The drill unit 32 may be designed to have a hollow drill bit similar to that disclosed in U.S. Patent Publication 2016/0345619, published on Dec. 1, 2016. The hollow drill bit may be able to collect the portion of the coconut being removed, thereby preventing debris from entering an interior of the coconut 12.

Alternatively, the drill unit 32 may have a blowing/suction unit 34 attached thereto. The blowing/suction unit 34 may be used to blow and/or vacuum the debris from the coconut 12 formed during the drilling process thereby preventing any debris from the coconut 12 from entering the interior of the coconut 12.

The device 12 may have a flavoring unit 36. The flavoring unit 36 may be used to inject different flavors, beverages, or similar items into the coconut 12, after the opening 14 has been drilled. The flavoring unit 36 may be formed of a plurality of containers 38. Each container 38 may contain a different flavoring 18, drink mix, alcoholic beverage, or similar mixing item (hereinafter flavoring 18). The containers 38 may each be coupled to a distribution unit 40. A sensor 26 may monitor an amount of the flavoring 18 being delivered by a respective container 38. When a desired amount of flavoring 18 has been delivered by one or more of the respective containers 38, the distribution unit 40 may transfer the one or more flavorings 18 to the interior of the coconut 12 via the opening 14. A nozzle 42 may be attached to the distribution unit 40 via a conduit 44 for transferring the contents of the containers 38 via the distribution unit 40. The nozzle 42 and conduit 44 may be movable in an up and down manner so that the nozzle 42 may protrude through the opening 28 of the housing 20 to deliver the contents to the interior of the coconut 12 via the opening 14. In accordance with one embodiment, the conduit 44 may be an extendable conduit with may extend and retract in order to move the nozzle 42.

In operation, the user of the device 10 may use the screen 22 or other I/O device to select and enter a desired mixture to be inserted into the coconut 12. Once the desired mixture is selected, the flavoring unit 36 may then transfer the one or more flavors 18 in the desired amount from the respective containers 38 to the distribution unit 40. The distribution unit 40 may then move the conduit 44 downward so that the nozzle 42 is inserted into the opening 14 of the coconut 12 in order to transfer the one or more flavors 18 into the interior of the coconut 12. In accordance with one embodiment, the flavoring unit 36 may be pressurized in order to deliver the different flavors 18 into the coconut 12.

The device 10 may have a capping unit 46. Once the drill unit 32 has formed the opening 14 in the coconut 12, and the drill unit 32 is retracted back inside the housing 20, the capping unit 46 may be able to seal the opening 14 with a resealable drinking spout 48 (hereinafter spout 48). The spout 48 may be similar to that discloses in U.S. Pat. Nos. 10,609,939, and 11,317,647.

The capping unit 46 may be movable in an up and down manner so that the capping unit 46 may protrude through the opening 28 of the housing 20 to seal the opening 14 with the spout 48. The capping unit 46 may insert a tip of the spout 48 into the opening 14 of the coconut 12 in order to seal the opening 14. Depending on the type of spout 48 used, the capping unit 46 may insert the tip of the spout 48 into the opening 14 and push the spout 48 downwards into the coconut 12. Alternatively, in accordance with one embodiment, the capping unit 46 may be rotatable. The capping unit 48 may rotate in order to engage threads of the spout 48 to screw into the opening 14 securing the spout 48 within the opening 14.

In accordance with one embodiment, the capping unit 46 may be coupled to an extendable arm 46A. The extendable arm 46A may have one end coupled to the housing 20 and a second end coupled to the capping unit 46. The extendable arm 46A may extend downward so that the capping unit 46 extends through the opening 28 of the housing 20 to reach the coconut 12 to be sealed. Once the spout 48 is inserted into the opening 14 in the coconut 12, the extendable arm 46A may be retracted so that the capping unit 46 may be positioned back within the housing 20.

The device 10 may have a branding unit 48. The branding unit 48 may be used to place a label 50 on the coconut 12. The label 50 may be a company brand 50A, a Universal Product Code (UPC) or other type of barcode 50B used for tracking inventory, text or the like. The user of the device 10 may use the screen 22 or other I/O device to enter a desired label 50 to be placed on the coconut 12. Once the desired label 50 is entered, the branding unit 48 may label the coconut 12 with the appropriate label 50. In accordance with one embodiment, the branding unit 48 may be a laser unit which etches the label 50 on the coconut 12.

In accordance with one embodiment, the branding unit 48 may be coupled to an extendable arm 48A. The extendable arm 48A may have one end coupled to the housing 20 and a second end coupled to the branding unit 48. The extendable arm 48A may extend downward so that the branding unit 48 extends through the opening 28 of the housing 20 to reach the coconut 12 to be branded. Once the proper label 50 has been placed on the coconut 12, the extendable arm 48A may be retracted so that the branding unit 48 may be positioned back within the housing 20.

The foregoing description is illustrative of particular embodiments of the invention, but is not meant to be a limitation upon the practice thereof. The following claims, including all equivalents thereof, are intended to define the scope of the invention.

What is claimed is:

1. A coconut processing device, comprising:
a drill unit forming an opening in a coconut; and
a capping unit inserting a spout into the opening sealing the opening.

2. The coconut processing device of claim 1, comprising a flavoring unit placing a desired flavoring in the coconut.

3. The coconut processing device of claim 1, comprising a branding unit placing a label on the coconut.

4. The coconut processing device of claim 1, comprising a holding device securing the coconut in position.

5. The coconut processing device of claim 1, comprising a first retractable arm coupled to the drill unit moving the drill unit upwards and downwards.

6. The coconut processing device of claim 1, comprising a second retractable arm coupled to the capping unit moving the capping unit upwards and downwards.

7. The coconut processing device of claim 2, wherein the flavoring unit comprises:
a plurality of containers, wherein each container stores a flavoring; and
a distribution unit coupled to the plurality of containers collecting at least one flavoring to be placed in the coconut.

8. The coconut processing device of claim 7, wherein the flavoring unit comprises:
a conduit coupled to the distribution unit; and
a nozzle coupled to the conduit.

9. The coconut processing device of claim 8, wherein the conduit is retractable.

10. The coconut processing device of claim 3, wherein the branding unit places a label on the coconut.

11. The coconut processing device of claim 10, wherein the label is one of a company name or a inventory code.

12. The coconut processing device of claim 3, wherein the branding unit is a laser.

13. The coconut processing device of claim 1, comprising a securing device holding the coconut in position.

14. A coconut processing device, comprising:
a housing having an opening formed in a bottom area of the housing;
a stand positioned under the housing holding the housing;
a retractable drill unit movable in and out of the housing forming an opening in a coconut positioned below the opening in the housing;
a retractable capping unit movable in and out of the housing inserting a spout into the opening in the coconut sealing the opening in the coconut;
a retractable flavoring unit placing a flavoring in the coconut; and
a retractable branding unit movable in and out of the housing placing a label on the coconut.

15. The coconut processing device of claim 14, comprising a holding device coupled to the housing securing the coconut blow the opening in the housing.

16. The coconut processing device of claim 14, comprising a first retractable arm coupled to the drill unit moving the drill unit upwards and downwards in and out of the housing.

17. The coconut processing device of claim 16, comprising a second retractable arm coupled to the capping unit moving the capping unit upwards and downwards in and out of the housing.

18. The coconut processing device of claim 14, wherein the flavoring unit comprises:
a plurality of containers coupled to the housing, wherein each container stores a flavoring; and
a distribution unit coupled to the plurality of containers collecting at least one flavoring to be placed in the coconut.

19. The coconut processing device of claim 18, wherein the flavoring unit comprises:
a retractable conduit coupled to the distribution unit; and
a nozzle coupled to the conduit.

20. The coconut processing device of claim 14, wherein the branding unit is a laser.
